(19) United States
(12) Patent Application Publication
(10) Pub. No.: US 2016/0018715 A1
(43) Pub. Date: Jan. 21, 2016

(54) ELECTRONIC PAPER DISPLAY DEVICE

(71) Applicant: E Ink Holdings Inc., HSINCHU (TW)

(72) Inventors: Shu-Ping YAN, HSINCHU (TW); Shu-Hao CHANG, HSINCHU (TW); Pei-Lin HUANG, HSINCHU (TW)

(21) Appl. No.: 14/720,989

(22) Filed: May 26, 2015

(30) Foreign Application Priority Data
Jul. 21, 2014 (TW) 103124933

(51) Int. Cl. G02F 1/167; G02B 1/14

(52) U.S. Cl. CPC G02F 1/167; G02B 1/14; G02F 2001/1676

(57) ABSTRACT

An electronic paper display device includes a substrate, a protection sheet, an e-ink (electronic-ink) layer, a first electrode layer, and a second electrode layer. The e-ink layer is located between the substrate and the protection sheet. The e-ink layer has a display area and a surrounding area. The display area is surrounded by the surrounding area. The first electrode layer is located between the e-ink layer and the substrate, and the first electrode layer is corresponding to the display area in position. The second electrode layer is located between the e-ink layer and the substrate, and the second electrode layer is corresponding to the surrounding area in position.

### RELATED APPLICATIONS

This application claims priority to Taiwanese Application Serial Number 103124933, filed Jul. 21, 2014, which is herein incorporated by reference.

### BACKGROUND

1. Field of Invention

The present invention relates to a display device. More particularly, the present invention relates to an electronic paper display device.

2. Description of Related Art

In the current market of various consumer electronic products, portable electronic devices, such as electronic books, have extensively utilized electronic paper display devices as display screens. An electronic ink (e-ink) layer of an electronic paper display device mainly consists of an electrophoresis buffer and white and black charged particles in the electrophoresis buffer. The white and black charged particles are movably driven by applying a voltage to the e-ink layer, so as to present each of pixels with black, white or a gray level. In the electronic paper display device, an incident light irradiating the e-ink layer is used to achieve the purpose of display. Therefore, the electronic paper display device needs no backlight and the power consumption of the electronic paper display device would be reduced. The incident light may be sunlight or indoor ambient light.

In recent years, consumers demand increasingly higher standards with respect to the outer appearance of electronic products, and thus frame widths of the electronic paper display devices get narrower. The area of an electronic paper display device exposed through an opening of the frame may be referred to as a display area. As a result, circuits between the display area and an edge of a glass substrate of the electronic paper display device has to be greatly decreased, such that the e-ink layer outside the display area cannot be controlled by a technical person.

However, during the manufacture of the electronic paper display device, it is very important to test whether the electronic paper display device is normal or not, especially the e-ink layer. When the display area of the electronic paper display device displays an image, the e-ink layer in the area between the display area and the edge of the glass substrate cannot be controlled due to lacking of circuits, thus resulting display errors or noises, increasing judgment difficulty of the technical person.

### SUMMARY

An aspect of the present invention is to provide an electronic paper display device.

According to an embodiment of the present invention, an electronic paper display device includes a substrate, a protection sheet, an e-ink (electronic-ink) layer, a first electrode layer, and a second electrode layer. The e-ink layer is located between the substrate and the protection sheet. The e-ink layer has a display area and a surrounding area. The display area is surrounded by the surrounding area. The first electrode layer is located between the e-ink layer and the substrate, and the first electrode layer is corresponding to the display area in position. The second electrode layer is located between the e-ink layer and the substrate, and the second electrode layer is corresponding to the surrounding area in position.

In one embodiment of the present invention, the electronic paper display device further includes a metal layer and an isolation layer. The metal layer is located on the substrate. The isolation layer is located between the metal layer and the second electrode layer.

In one embodiment of the present invention, the isolation layer includes a first isolation layer, a second isolation layer, and an overcoat layer. The first isolation layer is located on the metal layer. The second isolation layer is located on the first isolation layer. The overcoat layer is located on the second isolation layer.

In one embodiment of the present invention, the second electrode layer is located on the overcoat layer.

In one embodiment of the present invention, the overcoat layer is made of a material including photoresist.

In one embodiment of the present invention, the first and second isolation layers are made of a material including silicon nitride.

In one embodiment of the present invention, the electronic paper display device further includes a flexible printed circuit board. The flexible printed circuit board is electrically connected to the first and second electrode layers.

In one embodiment of the present invention, the e-ink layer includes a plurality of microcapsules.

In one embodiment of the present invention, a portion of the microcapsules is located between the protection sheet and the second electrode layer.

In one embodiment of the present invention, the microcapsules between the protection sheet and the second electrode layer are located in the surrounding area of the e-ink layer.

In one embodiment of the present invention, a portion of the microcapsules is located between the protection sheet and the first electrode layer.

In one embodiment of the present invention, the microcapsules between the protection sheet and the first electrode layer are located in the display area of the e-ink layer.

In one embodiment of the present invention, the first and second electrode layers are spaced from each other at a distance.

In one embodiment of the present Invention, the protection sheet is made of a material including plastic.

In the aforementioned embodiments of the present invention, the electronic paper display device includes the second electrode layer, and the second electrode layer is corresponding to the surrounding area of the e-ink layer in position. Therefore, when the second electrode layer is controlled by an external signal, the e-ink layer located above the second electrode layer can be driven. As a result, the e-ink layer located between the protection sheet and the first electrode layer and the e-ink layer located between the protection sheet and the second electrode layer may display images. That is to say, a technical person may use the first and second electrode layers to drive the entire e-ink layer, thereby determining whether the electronic paper display device is normal or not, which is used as a reference for shipment. Therefore, the product competitiveness of the electronic paper display device may be improved.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a top view of an electronic paper display device according to one embodiment of the present invention;

FIG. 2 is a cross-sectional view of the electronic paper display device taken along line 2-2 shown in FIG. 1;

FIG. 3 is a schematic view of an electronic paper display device connected to a test board when being tested according to one embodiment of the present invention; and

FIG. 4 is a schematic view of an electronic paper display device connected to a test board when being tested according to one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

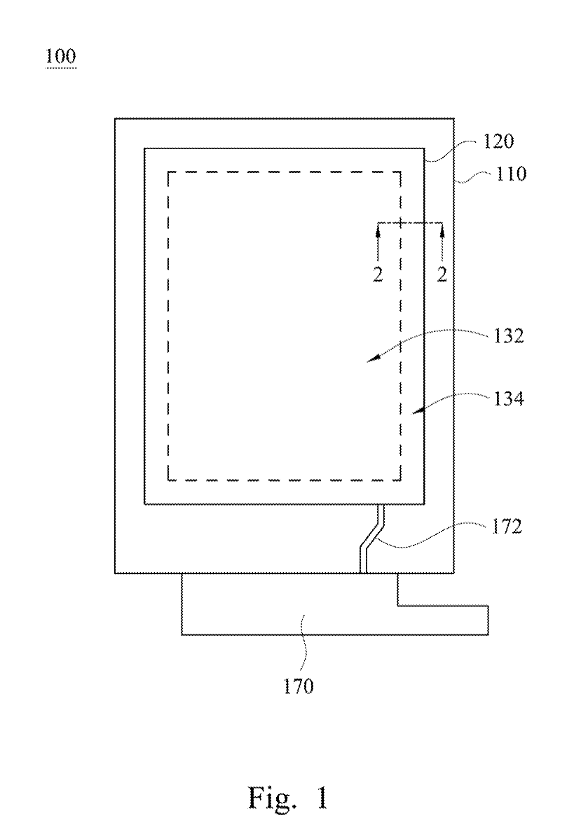

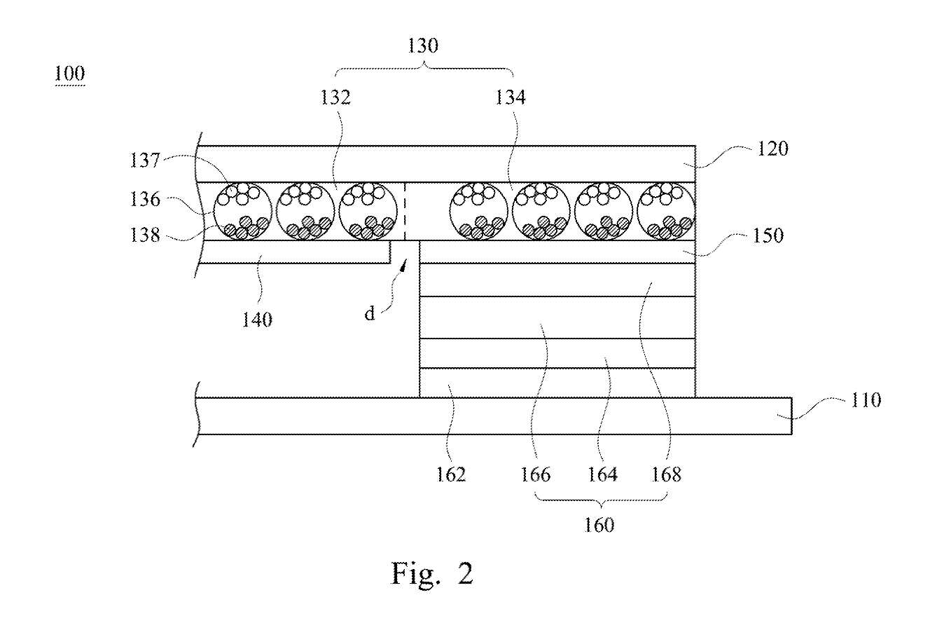

FIG. 1 is a top view of an electronic paper display device 100 according to one embodiment of the present invention. FIG. 2 is a cross-sectional view of the electronic paper display device 100 taken along line 2-2 shown in FIG. 1. As shown in FIG. 1 and FIG. 2, the electronic paper display device 100 includes a substrate 110, a protection sheet 120, an e-ink layer 130, a first electrode layer 140, and a second electrode layer 150. The e-ink layer 130 is located between the substrate 110 and the protection sheet 120. The e-ink layer 130 has a display area 132 and a surrounding area 134, and the display area 132 is surrounded by the surrounding area 134. The display area 132 is referred to as an area surrounded by the dotted line of FIG. 1, and an area at the left side of the dotted line of FIG. 2. The surrounding area 134 is referred to as an area between the dotted line and the edge of the protection sheet 120 shown in FIG. 1, and an area at the right side of the dotted line of FIG. 2. In subsequent processes for manufacturing the electronic paper display device 100, a frame may be used to cover the area outside the dotted line of FIG. 1, such that the display area 132 is corresponding to the opening of the frame in position. In the present disclosure, the term “corresponding” means “substantially overlapping and aligned”.

The first electrode layer 140 is located between the e-ink layer 130 and the substrate 110, and the first electrode layer 140 is corresponding to the display area 132 in position. The second electrode layer 150 is located between the e-ink layer 130 and the substrate 110, and t the second electrode layer 150 is corresponding to the surrounding area 134 in position. That is to say, the first electrode layer 140 is located under the display area 132, and the second electrode layer 150 is located under the surrounding area 134.

The protection sheet 120 and the e-ink layer 130 may be referred to as a front plane laminate (FPL) of the electronic paper display device 100. In this embodiment, the protection sheet 120 may he made of a material including plastic, such as PET or PMMA. The substrate 110 may be an array substrate having pixel units. The substrate 110 may be made of a material including glass. The e-ink layer includes a plurality of microcapsules 136. Each of the microcapsules 136 has light-colored electrophoresis particles 137 (e.g., white particles) and dark-colored electrophoresis particles 138 (e.g., black particles).

A portion of the microcapsules 136 is located between the protection sheet 120 and the second electrode layer 150, and another portion of the microcapsules 136 is located between the protection sheet 120 and the first electrode layer 140. That is to say, the microcapsules 136 between the protection sheet 120 and the second electrode layer 150 are located in the surrounding area 134 of the e-ink layer 130, and the microcapsules 136 between the protection sheet 120 and the first electrode layer 140 are located in the display area 132 of the e-ink layer 130. The first and second electrode layers 140, 150 are spaced from each other at a distance d, and therefore the first and second electrode layers 140, 150 do not conduct to form a short circuit.

In operation, the electric field of the display area 132 of the e-ink layer 130 may be changed by controlling the first electrode layer 140, and the electric field of the surrounding area 134 of the e-ink layer 130 may be changed by controlling the second electrode layer 150. When the light-colored electrophoresis particles 137 are located at the upper side of the e-ink layer 130, and the dark-colored electrophoresis particles 138 are located at the lower side of the e-ink layer 130, the light-colored electrophoresis particles 137 may reflect an incident light so as to display a bright (e.g., white) surface. Alternatively, when the light-colored electrophoresis particles 137 are at the lower side of the e-ink layer 130, and the dark-colored electrophoresis particles 138 are at the upper side of the e-ink layer 130, the dark-colored electrophoresis particles 138 do not reflect an incident light so as to display a dark (e.g., black) surface.

In this embodiment, the electronic paper display device 100 may further include an isolation layer 160 and a metal layer 162. The isolation layer 160 is located between the metal layer 162 and the second electrode layer 150. The isolation layer 160 includes a first isolation layer 164, a second isolation layer 166, and an overcoat layer 168. The metal layer 162 is located on the substrate 110. The first isolation layer 164 is located on the metal layer 162. The second isolation layer 166 is located on the first isolation layer 164. The overcoat layer 168 is located on the second isolation layer 166. The second electrode layer 150 is located on the overcoat layer 168. The overcoat layer 168 may be made of a material including photoresist. The first and second isolation layers 164. 166 may be made of a material including silicon nitride. The metal layer 162 may be made of a material including titanium, aluminum, and alloys thereof.

When the electronic paper display device 100 is manufactured, the metal layer 162, the first and second isolation layers 164, 166, the overcoat layer 168, the first and second electrode layers 140,150 may be formed on the substrate 110 by selectively utilizing physical vapor deposition (PVD) method, chemical vapor deposition (CVD) method, and photolithography technique. The photolithography technique may include exposure, development, and etching processes.

It is to be noted that the connection relationships and materials of the elements described above will not be repeated in the following description, and only aspects related to the electronic paper display device 100 under test will be described.

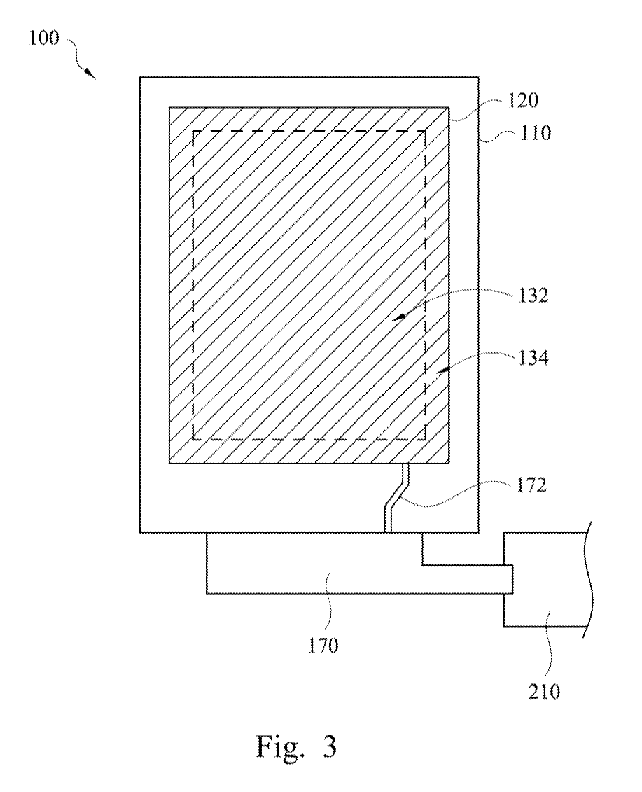

FIG. 3 is a schematic view of an electronic paper display device 100 connected to a test board 210 when being tested according to one embodiment of the present invention. As show in FIG. 2 and FIG. 3, the electronic paper display device 100 may further include a flexible printed circuit board 170. The flexible printed circuit board 170 may be electrically connected to the first and second electrode layers 140, 150 by a conductive line 172. When the electronic paper display device 100 is under test, the flexible printed circuit board 170 may be electrically connected to the test board 210. A technical person may input a signal to the test board 210, such that the test board 210 can control the electrical properties of the first and second electrode layers 140, 150 through the flexible printed circuit board 170 and the conductive line 172. After the integrated circuit (IC) of the electronic paper display device 100 receives the signal, the display area 132 may be controlled to display a specific image and a specific color.

The electronic paper display device 100 includes the second electrode layer 150, and the second electrode layer 150 is corresponding to the surrounding area 134 of the e-ink layer 130 in position. Therefore, when the second electrode layer 150 is controlled by the signal of the test board 210, the e-ink layer 130 located above the second electrode layer 150 can be driven to form an image in the surrounding area 134, such as a black image, a white image, or a gray level image. As a result, the e-ink layer 130 between the protection sheet 120 and the first electrode layer 140 (i e. the display area 132) and the e-ink layer 130 between the protection sheet 120 and the second electrode layer 150 (Le., the surrounding area 134) both may display images. Hence, the problem of a conventional surrounding area having no images or having interference can be prevented.

For example, when the electronic paper display device 100 is under test, the display area 132 and the surrounding area 134 may display the same image. The slanted lines of the display area 132 and the surrounding area 134 shown in FIG. 3 may be referred to as a black image, a white image, or a gray level image. A technical person may use the signal of the test board 210 to control the first and second electrode layers 140, 150, thereby driving the entire e-ink layer 130 to determine whether the electronic paper display device 100 is normal or not, which can be used as a reference for shipment. Therefore, an electronic product having the electronic paper display device 100 of the present invention may significantly improve the yield and reliability of the product, and thus the electronic paper display device 100 has better product competitiveness.

In addition, the second electrode layer 150 is located under the surrounding area 134 of the e-ink layer 130, so that the second electrode layer 150 does not occupy the surface of the substrate 110 between the edge of the substrate 110 and the edge of the protection sheet 120. In this regard, the electronic paper display device 100 may be utilized in a display device with the design of a narrow frame, so as to be flexibly used by designers.

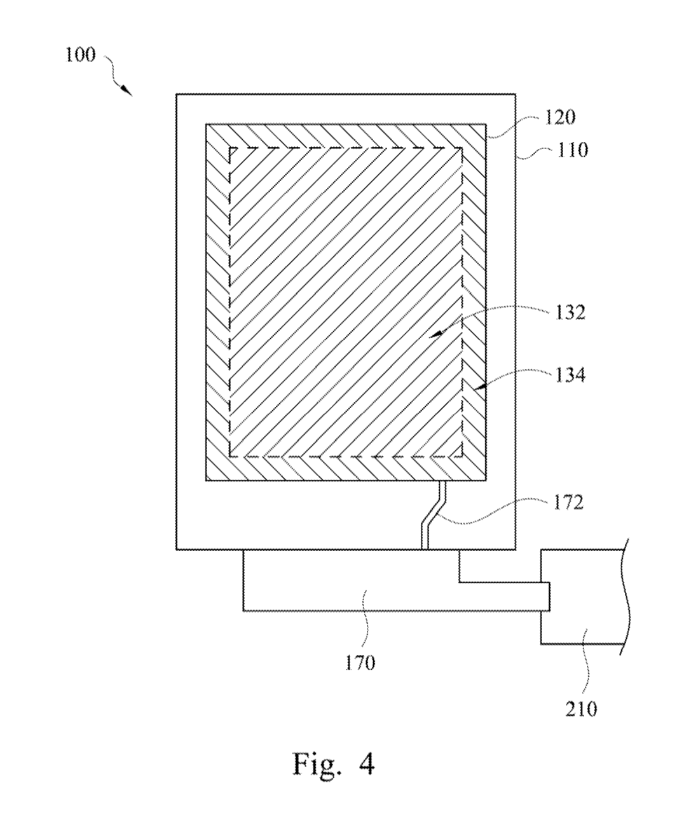

FIG. 4 is a schematic view of an electronic paper display device 100 connected to a test board 210 when being tested according to one embodiment of the present invention. The difference between this embodiment and the embodiment shown in FIG. 3 is that, when the electronic paper display device 100 is under test, the display area 132 and the surrounding area 134 display different images. For example, the slanted lines of the display area 132 shown in FIG. 4 may indicate combinations of a specific image and a specific color, and the slanted lines of the surrounding area 134 shown in FIG. 4 may indicate a black image, a white image, or a gray level image. In this embodiment, although the display area 132 and the surrounding area 134 display different images, a technical person may still use the signal of the test board 210 to control the first and second electrode layers 140, 150, thereby driving the entire e-ink layer 130 to determine whether the electronic paper display device 100 is normal or not.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electronic paper display device, comprising:
a substrate;
a protection sheet;
an electronic-ink layer located between the substrate and the protection sheet and the electronic-ink layer having a display area and a surrounding area, wherein the display area is surrounded by the surrounding area;
a first electrode layer located between the electronic-ink layer and the substrate, wherein the first electrode layer is corresponding to of the display area in position; and
a second electrode layer located between the electronic-ink layer and the substrate, wherein the second electrode layer is corresponding to the surrounding area in position.

2. The electronic paper display device of claim 1, further comprising:
a metal layer located on the substrate; and
an isolation layer located between the metal layer and the second electrode layer.

3. The electronic paper display device of claim 2, wherein the isolation layer comprises:
a first isolation layer located on the metal layer;
a second isolation layer located on the first isolation layer; and
an overcoat layer located on the second isolation layer.

4. The electronic paper display device of claim 3, wherein the second electrode layer s located on the overcoat layer.

5. The electronic paper display device of claim 3, wherein the overcoat layer is made of a material comprising photoresist.

6. The electronic paper display device of claim 3, wherein the first and second isolation layers are made of a material comprising silicon nitride.

7. The electronic paper display device of claim 1, further comprising:
a flexible printed circuit board electrically connected to the first and second electrode layers.

8. The electronic paper display device of claim 1, wherein the electronic-ink layer comprises a plurality of microcapsules.

9. The electronic paper display device of claim 8, wherein a portion of the microcapsules is located between the protection sheet and the second electrode layer.

10. The electronic paper display device of claim 9, wherein the microcapsules between the protection sheet and the second electrode layer are located in the surrounding area of the electronic-ink layer.

11. The electronic paper display device of claim 8, wherein a portion of the microcapsules is located between the protection sheet and the first electrode layer.

12. The electronic paper display device of claim 11, wherein the microcapsules between the protection sheet and the first electrode layer are located in the display area of the electronic-ink layer.

13. The electronic paper display device of claim 1, wherein the first and second electrode layers are spaced from each other at a distance.

14. The electronic paper display device of claim 1, wherein the protection sheet is made of a material comprising plastic.
